(19) United States
(12) Patent Application Publication
(10) Pub. No.: US 2019/0102365 A1
(43) Pub. Date: Apr. 4, 2019

(54) METHOD AND APPLICATION FOR PROVIDING CARD NEWS PRODUCING SERVICE

(71) Applicant: Tubloo Co.,Ltd., Seoul (KR)

(72) Inventor: Heung Hyun LEE, Seoul (KR)

(73) Assignee: Tubloo Co.,Ltd., Seoul (KR)

(21) Appl. No.: 16/147,097

(22) Filed: Sep. 28, 2018

(30) Foreign Application Priority Data
Sep. 29, 2017 (KR) 10-2017-0127723

(51) Int. Cl. G06F 17/21; H04L 12/58; G06F 17/24; G06T 11/00; G06T 11/60

(52) U.S. Cl. CPC G06F 17/212; H04L 51/02; G06F 17/214; G06T 11/001; G06T 11/60; G06F 17/24

(57) ABSTRACT

Disclosed is a method for providing a card news producing service including obtaining, by a computer, a message for requesting generation of card news from a user, extracting content of the card news from the obtained message, generating a layout of the card news based on at least one of request items included in the extracted content and the message, placing a text corresponding to the extracted content of the card news in the generated layout, determining a design of the placed text, determining a background of the card news, and providing the card news to the user.

### CROSS-REFERENCE TO RELATED APPLICATIONS

A claim for priority under 35 U.S.C. § 119 is made to Korean Patent Application No. 10-2017-0127723 filed on Sep. 29, 2017 in the Korean Intellectual Property Office, the entire contents of which are hereby incorporated by reference.

### BACKGROUND

Embodiments of the inventive concept described herein relate to a method and an application for providing card news producing service.

Due to the development of the mobile environment, the form of content is becoming simpler than ever. In this process, the card news capable of combining an image and a text to transmit a message to a user simply is widely used.

The card news is widely used not only for news but also for advertisement and knowledge transfer, as the content in a form of a short text and an image. However, amateurs will have difficulty in selecting an image and placing texts to produce card news when producing the card news, and also have difficulty in solving the copyright problem according to image usage.

In addition, while a messenger-type or chat room-type interface is widely used for users as another phenomenon occurring due to the development of the mobile environment, an interactive user interface has appeared which is called a “ChatBot”, instead of a user interface using a keyboard and a mouse or a touch input.

The ChatBot is a user interface that allows a user to interactively obtain desired results using a messenger application. Nowadays, the ChatBot technology capable of grasp the user's intent by using an artificial intelligence (AI) technology in addition to the predetermined response and providing various services is being developed.

### SUMMARY

Embodiments of the inventive concept provide a method and an application for providing a card news producing service.

According to an aspect of an embodiment, a method for providing a card news producing service includes obtaining, by a computer, a card news generating request from a user, extracting content of the card news from the obtained card news generating request, generating a layout of the card news based on at least one of request items included in the extracted content and the card news generating request, placing a text corresponding to the extracted content of the card news in the generated layout, determining a design of the placed text, determining a background of the card news, and providing the card news to the user.

According to another aspect of an embodiment, the method further includes obtaining a feedback on the provided card news from the user, extracting a revised item associated with the card news from the feedback, revising the card news depending on the revised item, and providing the revised card news to the user.

According to another aspect of an embodiment, the revising of the card news further includes changing a design of at least one of a text and a background of the revised card news to enhance visibility of the text of the revised card news.

According to another aspect of an embodiment, the changing of the design includes increasing a brightness difference between the text and the background of the revised card news so as to enhance the visibility of the text of the revised card news, and the changing of the design includes changing a color of the background of the card news or an image included in the background of the card news, when a color of a text of the card news is changed depending on the revised item and changing the color of the text of the card news, when the background of the card news is changed depending on the revised item.

According to another aspect of an embodiment, the determining of the background of the card news includes determining at least one image to be included in the background of the card news, and the determining of the background of the card news includes determining an image corresponding to the content of the extracted card news.

According to another aspect of an embodiment, the generating of the layout includes generating the layout based on at least one of a channel in which the card news is to be distributed, an amount of texts to be placed in the layout, a type of a text to be placed in the layout, and a type of a page to which the layout is to be applied.

According to another aspect of an embodiment, the generating of the layout includes generating one or more layers corresponding to each component of the layout, and the one or more layers includes one or more of a background layer, an image layer, a box layer, a logo layer, a body text layer, and a title text layer.

According to another aspect of an embodiment, the placing of the text includes classifying the text as at least one of a title text and a body text and placing the classified text in a corresponding layer.

According to another aspect of an embodiment, the placing of the text further includes adjusting a line wrapping and a font size of the text such that the text is placed in an area where the text is to be placed in the generated layout.

According to another aspect of an embodiment, an application stored in a computer-readable recording medium such that a computer is capable of performing the method for providing a card news producing service is provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a conceptual diagram schematically illustrating a system providing a card news producing service, according to an embodiment;

FIG. 2 is a flowchart illustrating a method of providing a card news producing service;

FIGS. 3 and 4 are views illustrating a process to generate and revise card news, according to an embodiment;

FIG. 5 is a view illustrating an embodiment of a method in which a server generates a layout of card news;

FIG. 6 is a flowchart illustrating a method for providing a card news producing service, according to another embodiment;

FIG. 7 is a view illustrating a plurality of themes, with which a server is capable of providing a user;

FIG. 8 is a view illustrating a layout of card news provided by a user; and

FIG. 9 is a view illustrating a flowchart of a method for producing card news in a loop form, according to a disclosed embodiment.

### DETAILED DESCRIPTION

Advantage points and features of the disclosure and a method of accomplishing thereof will become apparent from the following description with reference to the following figures, wherein embodiments will be described in detail with reference to the accompanying drawings. The inventive concept, however, may be embodied in various different forms, and should not be construed as being limited only to the illustrated embodiments. Rather, these embodiments are provided as examples so that the present disclosure will be thorough and complete, and will fully convey the concept of the inventive concept to those skilled in the art. The inventive concept may be defined by scope of the claims. Meanwhile, the terminology used herein to describe embodiments of the invention is not intended to limit the scope of the invention.

The terminology used herein is for the purpose of describing embodiments and is not intended to limit the invention. As used herein, the singular terms are intended to include the plural forms as well, unless the context clearly indicates otherwise. The terms “comprises” and/or “comprising” used herein does not exclude presence or addition of one or more other elements, in addition to the aforementioned elements. The same reference numerals denote the same elements throughout the specification. As used herein, the term “and/or” includes any and all combinations of one or more of the associated components. It will be understood that, although the terms “first”, “second”, etc., may be used herein to describe various components, these components should not be limited by these terms. These terms are only used to distinguish one component from another component. Thus, a first component discussed below could be termed a second component without departing from the teachings of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

The term “unit” or “module” used herein may refer to software or hardware such as field programmable gate array (FPGA) or application specific integrated circuit (ASIC), and the “unit” or “module” may perform some functions. However, the “unit” or “module” may be not limited to software or hardware. The “unit” or “module” may be configured to exist in an addressable storage medium or may be configured to reproduce one or more processors. Therefore, as an example, “units” or “module” may include various elements such as software elements, object-oriented software elements, class elements, and task elements, processes, functions, attributes, procedures, subroutines, program code segments, drivers, firmware, microcodes, circuits, data, databases, data structures, tables, arrays, and variables. Functions provided in “units” or “modules” and elements may be combined into a smaller number of “units” or “modules” and elements or may be divided into additional “units” or “modules” and elements.

In this specification, “card news” is understood as a concept capable of including all types of contents such as a text, an image, a video, and the like.

Hereinafter, embodiments of the present disclosure will be described in detail with reference to accompanying drawings.

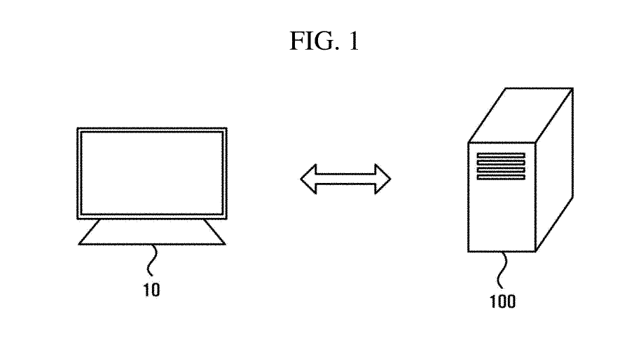

FIG. 1 is a conceptual diagram schematically illustrating a system providing a card news producing service, according to an embodiment.

Referring to FIG. 1, a system providing a card news producing service may include a computer 10 and a server 100. In addition, the computer 10 may refer to a user terminal or a user client, which is utilized by a user.

In this specification, each of the computer 10 and the server 100 refer to a computer including at least one processor, and the type and the shape of the computer are not limited thereto.

At least part of a method for providing the card news producing service according to a disclosed embodiment is performed on the computer 10 or the server 100.

According to an embodiment, the computer 10 transmits information for producing the card news to the server 100, and the server 100 generates the card news to provide the computer 10 with the card news.

According to another embodiment, the server 100 transmits a tool for producing the card news to the computer 10, and the computer 10 generates the card news by using the tool received from the server 100 and provides the user with the generated card news.

In this specification, “providing” is understood as a concept including transmitting information to another device and outputting the information by using an output device.

According to an embodiment, the tool for producing the card news consists of Single Page Application (SPA); when the card news is generated or the design is changed based on information input from a user, JavaScript may perform an operation according to an algorithm in background. However, this is provided as an example, and the subject, the specific tool, or the type of a language for performing the method of producing the card news according to a disclosed embodiment is not limited thereto.

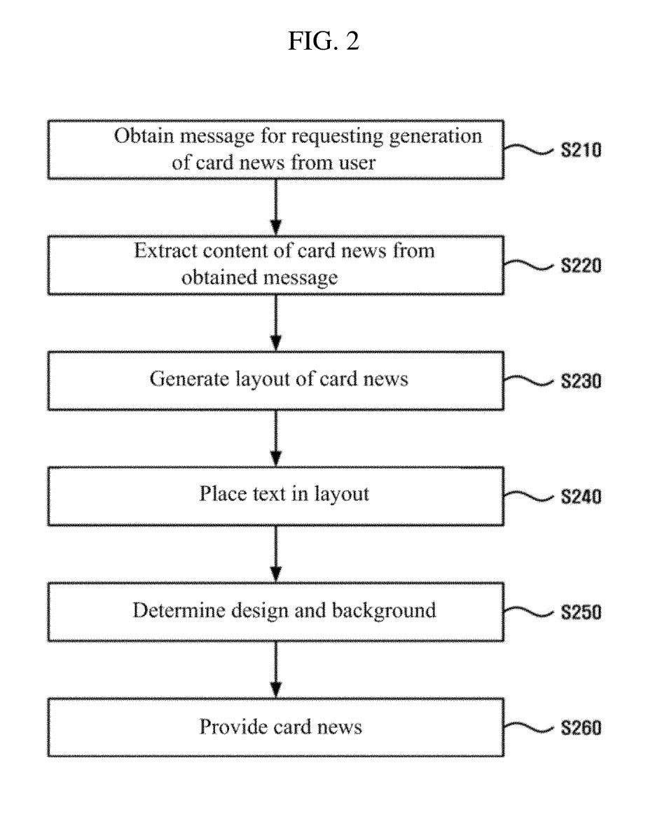

FIG. 2 is a flowchart illustrating a method of providing a card news producing service.

The method of providing a card news producing service illustrated in FIG. 2 consists of operations that are processed in a time-series manner by the computer 10 illustrated in FIG. 1. However, the subject of the method illustrated in FIG. 2 is not limited to the computer 10.

In operation S210, the computer 10 obtains a message for requesting the generation of the card news, from a user.

According to an embodiment, the message for requesting the generation of the card news may include a text included in the card news and a request item necessary to generate the card news.

According to an embodiment, the message for requesting the generation of the card news includes information about an image to be included in the card news.

According to an embodiment, the request item necessary to generate the card news may include one of pieces of information about the specification of the card news, the layout of the card news, the location at which a text is to be placed, the design of a text, the design of a background, the image to be included in the background, the location and the design of a box in which a text is placed, a request for the generation of a page of the card news, the page transition request, and the attribute of the page, and the type of the request item is not limited thereto.

In operation S220, the computer 10 extracts the content of the card news from the message obtained in operation S210.

The content of the card news includes at least one of a text and an image, which are to be included in the card news.

In operation S230, the computer 10 generates the layout of the card news based on at least one of request items included in the content extracted in operation S220 and the message obtained in operation S210.

According to an embodiment, the layout of the card news includes the specification of the card news and information about the location, the size, and the design of the content to be included in the card news.

Furthermore, the layout of the card news is generated based on at least one of a channel in which the card news is to be distributed, the amount of text to be placed in the layout, the type of a text to be placed in the layout, and the type of a page to which the layout is to be applied.

For example, the channel in which the card news is to be distributed includes the type of SNS in which the card news is to be distributed. Moreover, the type of a text to be placed in the layout includes information about whether the text to be placed in the layout is a title text or a body text. In addition, the type of a page to which the layout is to be applied may include information about whether the page is a title page or a body page.

For example, the card news may be generated for the purpose of uploading to specific SNS. In this case, the name of the specific SNS may be included in the request item included in the message obtained in operation S210, and the computer 10 may obtain information about SNS onto which the card news is to be uploaded, from the request item included in the message. The computer 10 may generate the card news; the computer 10 may generate the card news having a layout suitable for the specification of the specific SNS, onto which the generated card news is to be uploaded.

Furthermore, the computer 10 may generate the layout of the card news based on the content of the card news extracted in operation S220; the computer 10 may generate the layout of the card news such that all the pieces of content of the card news are placed in the card news depending on the amount of the extracted card news.

The computer 10 may additionally receive a message having a request for addition of the content of the card news; in this case, the computer 10 may change the layout of the card news so as to place all the pieces of added content.

In operation S240, the computer 10 places a text corresponding to the content of the card news extracted in operation S220, in the layout generated in operation S230.

According to an embodiment, the placing of the text includes classifying the text as at least one of a title text and a body text and placing the classified text in the corresponding layer.

Also, the placing of the text further includes adjusting the line wrapping and the font size of the text such that all of the texts are placed in an area where a text is to be placed in the generated layout.

In operation S250, the computer 10 determines the design of the placed text and the background of the card news.

According to an embodiment, the determining of the background of the card news includes determining at least one image included in the background of the card news; the determining of the background of the card news includes determining an image corresponding to the extracted content of the card news.

According to an embodiment, the at least one image to be included in the background of the card news may be designated by a user. When the image to be included in the background of the card news is not designated by the user, the computer 10 may extract one or more words appearing at a high frequency in the extracted content of the card news, may compare the extracted one or more words with metadata of each image included in an image database, and may automatically select an image that is highly associated with to the content of the card news.

The computer 10 selects at least one image from the internal or external database to include the at least one image in the card news. For example, the computer 10 may generate the card news by using the image database capable of providing images with copyright problems solved by paying a predetermined fee.

Furthermore, the determining of the design of the text includes determining the design of the text of the card news so as to enhance the visibility of the text placed in the card news. For example, as the difference in brightness between the background color of the card news and the color of the text placed in the card news increases, the visibility of the card news may be enhanced. Accordingly, the computer 10 may change the color of the text to be placed in the card news in consideration of the background color of the card news, thereby enhancing the visibility of the text.

For example, when the text is placed in the card news, an element that affects the visibility of the text includes at least one of the brightness of a box below the text, the image, and the brightness of a frame. Accordingly, the computer 10 may determine the background color of the text depending on a mean value, or a specific generated value in consideration of whether a box, an image, and a frame are present and the transparency of the box, the image, and the frame. The computer 10 may compare the brightness of the background color of the text with the brightness of the text; when the brightness difference does not reach a predetermined reference value, the computer 10 may forcibly lower or raise the brightness of at least one of the box, the image, and the frame to generate a brightness difference from the text.

When an enough brightness difference does not occur just only by adjusting the brightness of at least one of the box, the image, and the frame, the computer 10 may add effects such as outlines, shadows, background colors, or the like to the text such that a brightness difference greater than a predetermined reference value occurs between the background color and the color of the text.

According to an embodiment, the computer 10 may place a box including a location at which a text is to be place between the background and the text, thereby enhancing the visibility of the text and separating the background and the text. For example, the box consists of a translucent black rectangle and is placed on the background; and the text is a white color and is placed on the box, thereby enhancing the visibility of the text.

According to an embodiment, the color of the text may be determined in advance by the user's request item (i.e., a request item included in the message). In this case, the computer 10 may change the color of the background or an image included in the background, thereby enhancing the visibility of the text.

For example, the computer 10 may set the background color to a color with the great brightness difference from the color of the text. In addition, the computer 10 may determine a plurality of candidate images highly associated with keywords included in the text, and may select an image, which makes it possible to enhance the visibility of the text in consideration of the preset color of the text, from the candidate images to place the image in the card news.

Furthermore, the computer 10 may adjust the presence of the box and the color of the box, thereby enhancing the visibility of the text.

In operation S260, the computer 10 provides the user with the generated card news.

According to an embodiment, the computer 10 may provide the user with the finally completed card news; when each page is completed in producing card news or whenever the card news is generated or revised after each message is reflected, the computer 10 may provide the user with each page of the produced or revised card news.

According to a disclosed embodiment, a method of producing the card news may present the final result, not the work flow at the beginning and the end; the method of producing the card news may have a loop-typed work flow that repeatedly presents the final result at the request of the user, in the manner of presenting the final result to which a feedback is reflected, when the feedback according to the presented result is obtained.

Accordingly, according to a disclosed embodiment, a method of producing the card news may present the final result, to which the feedback is reflected, whenever the user's feedback is received, and thus the user may verify the final result and may determine whether to additionally revise the final result; furthermore, when the user obtains the desired final result, the user may immediately terminate the work, and thus the user may efficiently and quickly generate work result suitable for the user's intent.

Moreover, the user may transmit a message including a request for the revision of the provided card news, to the computer 10.

According to an embodiment, the computer 10 may generate a video by using the generated card news. For example, the computer 10 may generate a video that sequentially displays pages included in the generated card news in a slide show form.

According to an embodiment, the computer 10 generates the card news including an animation effect. For example, the animation effect may be applied to an object included in each page of the card news. Furthermore, the animation effect may also be used to a page transition effect according to transition between pages of the card news.

According to an embodiment, the computer 10 generates a video that sequentially displays pages included in the generated card news in a slide show form; the computer 10 generates a video including an animation effect according to page transition.

For example, the computer 10 may display each of the pages included in the generated card news; the computer 10 may apply an animation effect to at least part of an image and a text, which are included in each of the pages to generate a video for obtaining an effect to slowly read the content of the card news.

A method in which the computer 10 applies an animation effect to an object included in the card news is not limited thereto; the computer 10 may select and apply the animation effect to each object randomly, based on the predetermined rule, or based on context included in each object and then may generate a video.

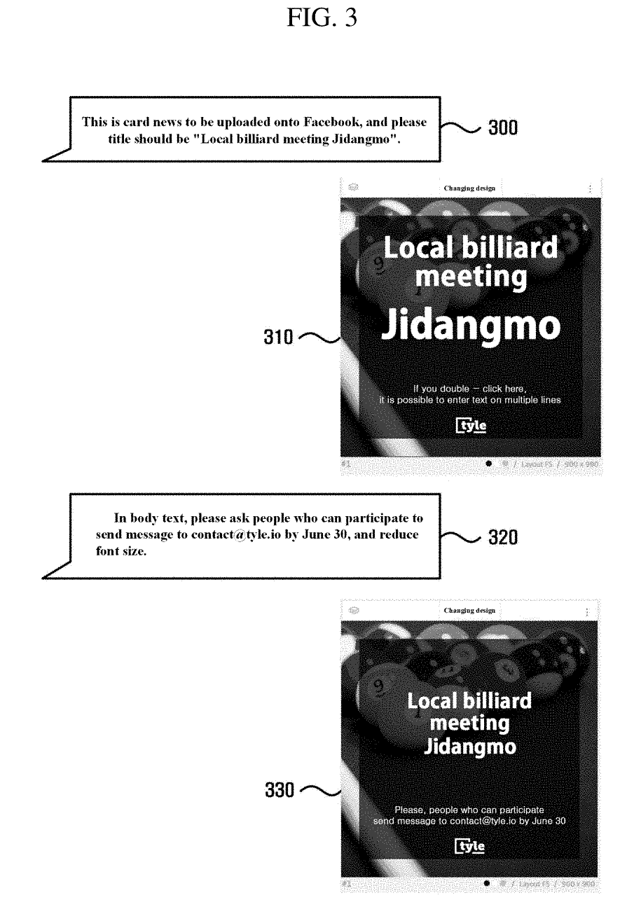

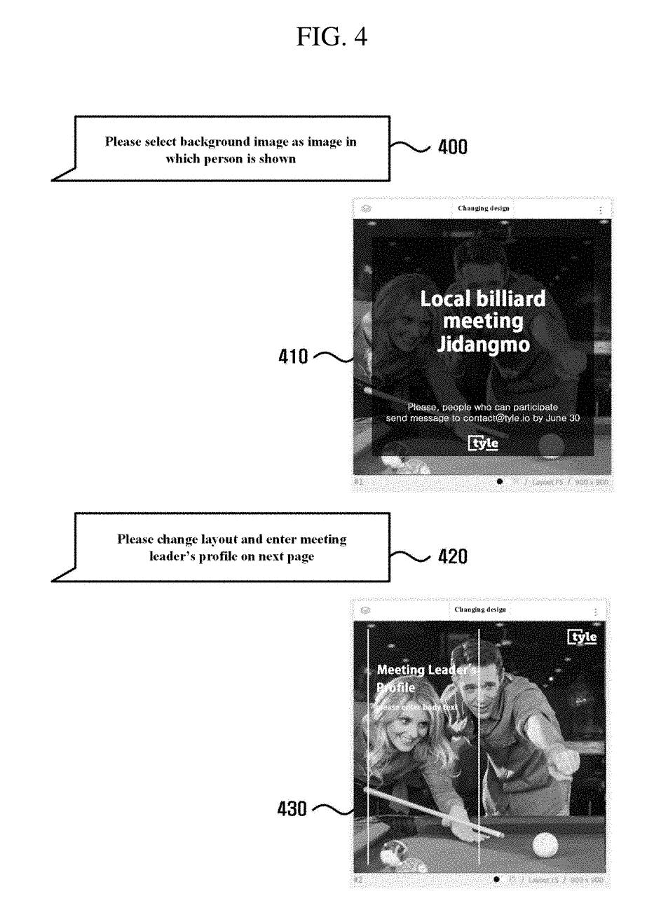

FIGS. 3 and 4 are views illustrating a process to generate and revise card news, according to an embodiment.

Referring to FIGS. 3 and 4, a process to generate and revise the card news is illustrated by using a chat room-typed user interface. However, according to a disclosed embodiment, the method of generating and revising the card news is not limited to the method using a user interface illustrated in FIGS. 3 and 4.

Referring to FIG. 3, the computer 10 receives a message 300 for requesting the generation of the card news, from a user.

The computer 10 extracts the content of the card news and the request item from received the message 300. According to an embodiment illustrated in FIG. 3, the content, which is included in the message 300 and which is to be included in the card news is a text “local billiard meeting Jidangmo”. In addition, the request item included in the message 300 is the card news to be posted on Facebook, and includes information indicating that the content (text) of the card news included in the message 300 is a title text.

Accordingly, the computer 10 generates the layout of the card news as the specification for uploading the card news to Facebook and generates a layout for inputting the title text.

The computer 10 places a text in the generated layout and places “local billiard meeting Jidangmo” in a title text layout depending on the request item.

Moreover, the computer 10 places the text in the layout such that all texts are capable of being included in the layout, favorably such that all texts are capable of being placed to fit the size of the layout.

Also, the computer 10 may search for an image from the keyword included in the content of the card news and may add the image corresponding to the content of the card news to the background.

For the purpose of enhancing the visibility of a text, the computer 10 may set the color of the text to white having great difference in brightness from the image added to the background of the card news, and may add a translucent black box between the text and the image, thereby enhancing the visibility of the text included in the card news.

The computer 10 provides a user with the generated card news 310.

Furthermore, the computer 10 receives a feedback message 320 of the card news 310, from the user.

The computer 10 extracts the revised item of the card news 310, from the feedback message 320.

For example, the computer 10 extracts a text to be added to the body of the card news 310 from the feedback message 320 and extracts the revised item for reducing the size of the text included in the existing card news 310.

When the layout, in which a body text is to be placed, is not included in the layout of the existing card news 310, the computer 10 adds the layout, in which the body text is placed, to the card news 310; when a space is insufficient, the computer 10 generates the entire layout of the card news 310 again.

The computer 10 places the extracted body text in the layout, which is included in the card news 310 and in which the body text will be placed. Likewise, the computer 10 places a text in a body text layout such that all texts are included in the layout; favorably, the computer 10 adjusts the size and the placement of the text such that the text is to be placed to fit the size of the layout.

In addition, the computer 10 determines information included in the text and may perform a function to highlight a portion determined as important content such as contacts, schedules, or the like or to change a font such as underlines, or the like.

The computer 10 revises the card news 310 based on the revised item extracted from the message 320. The computer 10 may reduce the size of a title text of the card news 310, based on the revised item extracted from the message 320.

The computer 10 provides the user with the revised card news 320.

According to an embodiment, the revised item extracted from the feedback message 320 may include a request to change the color of a text or a background image.

In this case, an operation in which the computer 10 revises the card news may further include changing the design of at least one of the text and the background of the revised card news so as to enhance the visibility of the text of the revised card news.

According to an embodiment, the changing of the design includes increasing a difference in brightness between a text and a background of the revised card news so as to enhance the visibility of a text of the revised card news; the changing of the design includes changing the background color of the card news or an image included in the background of the card news, when the color of a text of the card news is changed depending on the revised item and changing the color of the text of the card news, when the background of the card news is changed depending on the revised item.

For example, when the color of the text of the revised card news is changed to black, the computer 10 may search for a background image by using a keyword included in the text of the card news; the computer 10 may search for a plurality of candidate images corresponding to the keyword, may select a bright image with the great brightness difference from black among the candidate image, and may add the selected bright image to the background of the card news.

Likewise, when the background image of the revised card news is changed to a bright color, the computer 10 may change the color of a text included in the card news to a dark color.

According to another embodiment, for the purpose of solving the problem that the visibility is reduced depending on the color difference of the text or the background image of the revised card news, the computer 10 may add a box interposed between the background image and the text or may change the design of the box, such as a color, transparency, or the like, thereby enhancing the visibility of the text.

Referring to FIG. 4, the computer 10 may obtain a feedback message 400 of a card news 330 of FIG. 3 and may match the background of the card news 330 with the keyword of the existing card news depending on the revised item extracted from the message 400; the computer 10 may change the background of the card news by searching for an image in which a person is shown.

For example, the computer 10 may change the background of the card news by obtaining images, which are found by using “billiards” and “people” keywords from an internal or external image database or which includes tags.

The computer 10 may provide the user with revised card news 410.

According to an embodiment, the computer 10 may receive a message 420 for requesting the user to add a new page.

The computer 10 may extract the content of the card news and the request item from the message 420 to generate the layout of a new page and may place the content of the card news in the generated layout.

Referring to FIG. 4, the computer 10 extracts a request to generate a new page from the message 420 to generate a new page and may input “meeting leader's profile” as the title of the generated page.

According to an embodiment, the computer 10 may automatically fill the content of the text based on the pre-stored profile of a user.

According to an embodiment, the background of the newly generated page may be set to be the same as the background of another page, may be newly set depending on the content of a new page, and may be set to a new image in consideration of both the content of the existing page and the content of a new page.

For example, the computer 10 may change the background of the card news by searching for “billiards”, “people”, and “profile” keywords from an internal or external image database, or by obtaining images including tags.

The computer 10 may provide the user with a page 430 of the generated card news.

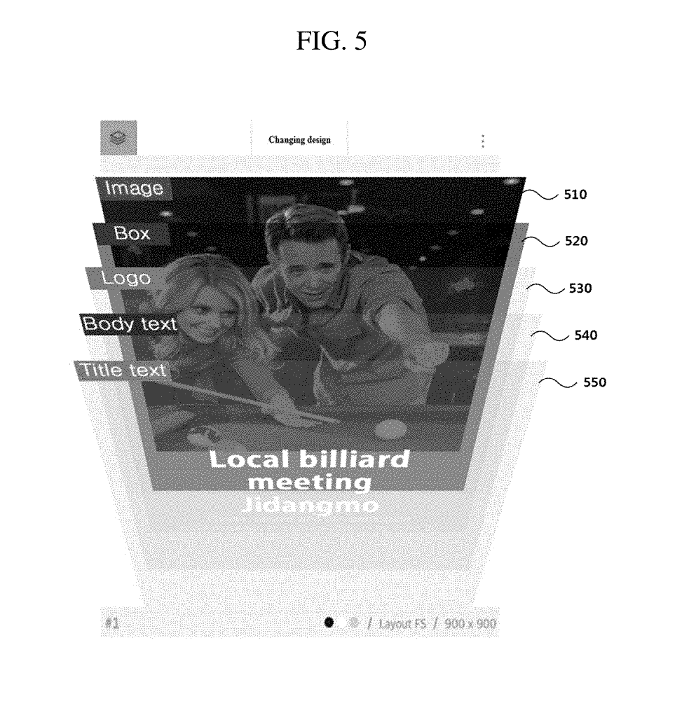

FIG. 5 is a view illustrating an embodiment of a method in which a server generates a layout of card news.

According to an embodiment, an operation in which the computer 10 generates the layout of the card news may include generating one or more layers corresponding to each component of the layout; the one or more layers may include one or more of a background layer, an image layer, a box layer, a logo layer, a body text layer, and a title text layer.

Referring to FIG. 5, a plurality of layers 510 to 550 constituting the layout of card news 500 are illustrated.

The type and the number of the plurality of layers 510 and 550 constituting the layout of the card news 500 are not limited to the embodiment illustrated in FIG. 5.

Referring to FIG. 5, the layout of the card news 500 includes the image layer 510, the box layer 520, the logo layer 530, the body text layer 540, and the title text layer 550.

An image corresponding to the background of the card news 500 is placed in the image layer 510.

A box, which is interposed between the image and the text and which makes it possible to enhance the visibility of the text, is placed in the box layer 520.

A logo that represents the source of the logo or the card news designated by the provider generating the logo or card news of a provider providing the card news producing service is placed in the logo layer 530.

A body text is placed in the body text layer 540, and a title text is placed in the title text layer 550.

According to an embodiment, a part of the plurality of layers 510 to 550 are allowed to overlap with each other, and the other parts need to overlap with each other or are allowed to overlap with each other.

For example, pieces of content the logo layer 530, the body text layer 540, and the title text layer 550 may not overlap with each other.

On the other hand, pieces of content of the image layer 510 and the remaining layers 520 to 550 may overlap with each other; according to an embodiment, pieces of content of the other layers 520 to 550 may be placed in consideration of the color of the image included in the image layer 510 or the location of the object included in the image.

In addition, the box layer 520 may overlap with pieces of content of the body text layer 540 and the title text layer 550 and may be placed such that the body text and the title text are included in the box.

According to an embodiment, when the frame of the card news 500 and the image layer 510, the box layer 520, the logo layer 530, the body text layer 540, and the title text layer 550, which are included in the frame, are sequentially placed, the sizes of components included in each layer are set based on the sizes of components included in the firstly placed layer.

For example, an image may not be set to be greater than a frame. Likewise, a box may not be set to be greater than an image, and a body text and a title text may not be set to be greater than a box.

According to an embodiment, the size of each component placed may not be fixed; even in the case of already placed component, the size may be configured so as to be adjusted depending on a predetermined ratio. For example, each component is placed to have a size capable of being adjusted within a range of about 20%, and is adjusted depending on the sizes and locations of the components that will be placed afterward. After all the components are placed, the size of each of the component may be determined.

Accordingly, the size of each of the components is set to be organically connected to each other, and thus the sizes of the components included in the final result are not biased extremely or set differently but are set to a stable size.

According to an embodiment, the computer 10 may extract the generated card news at the request of the user. For example, the computer 10 may terminate the generation of the card news depending on a request message of the user and may extract the completed card news to generate and store a document file, an image file, a presentation file, or the like or to provide the user.

Moreover, the computer 10 may upload the generated card news onto the user's SNS at the request of the user. At this time, the computer 10 may obtain the type of SNS, onto which the card news is to be uploaded, from information, which is obtained in operation S220, about a channel, in which the card news is to be distributed, and may review the card news depending on the policy of the obtained SNS.

For example, the computer 10 may obtain the policy of the SNS onto which the generated card news is uploaded, and may determine whether the generated card news conforms to a policy such as an inclination to gambling, sexuality, and publicity standards of the obtained policy. The computer 10 may provide the user with information about a portion determined as being inappropriate in the generated card news or may automatically revise the information. The computer 10 may suggest an amendment associated with the portion to be revised to the user, and may revise the card news depending on the user's selection.

According to another embodiment, in the process to generate the card news, the computer 10 may compare the content of the card news and the request item, which are included in the user's message, with the policy of SNS onto which the card news is to be uploaded; when the inappropriate content or the inappropriate request item is included in the message, the computer 10 may provide a user with a feedback. The user may correct the content of the card news and the request item for generating the card news depending on the feedback of the computer 10, and thus may generate the card news capable of being immediately uploaded onto the SNS without any problems.

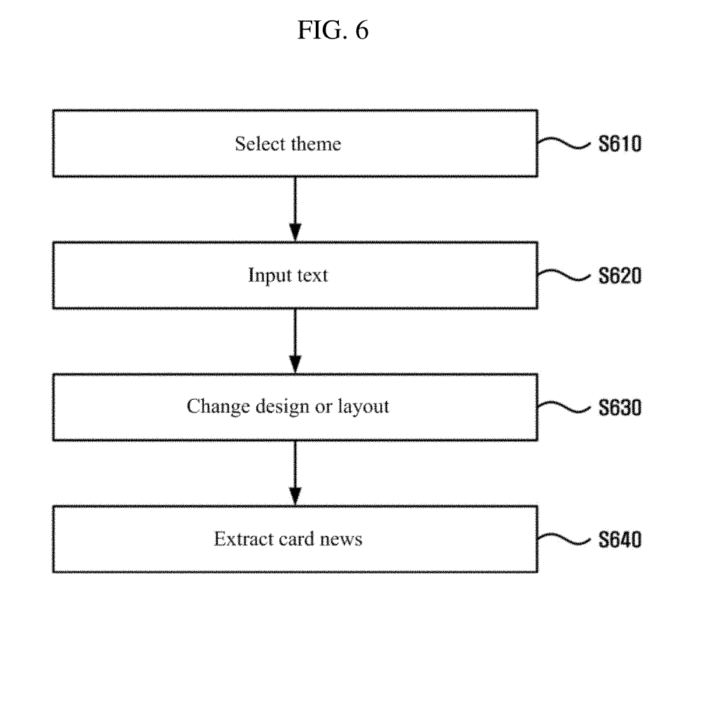

FIG. 6 is a flowchart illustrating a method for providing a card news producing service, according to another embodiment.

The method of providing a card news producing service illustrated in FIG. 6 consists of operations that are performed in a time-series manner by the computer 10 illustrated in FIG. 1.

In operation S610, the computer 10 receives a selection input to select at least one theme from a user.

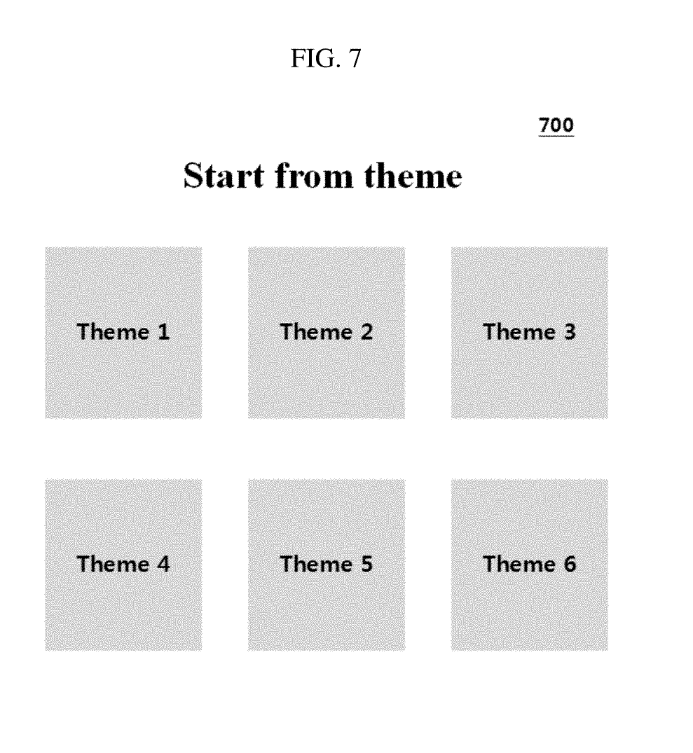

Referring to FIG. 7, a plurality of themes 700, with which the computer 10 is capable of providing the user, are illustrated.

The computer 10 provides the user with a layout according to the theme that the user selects. The method described with reference to FIGS. 1 to 5 is applied to a method in which the computer 10 generates a layout.

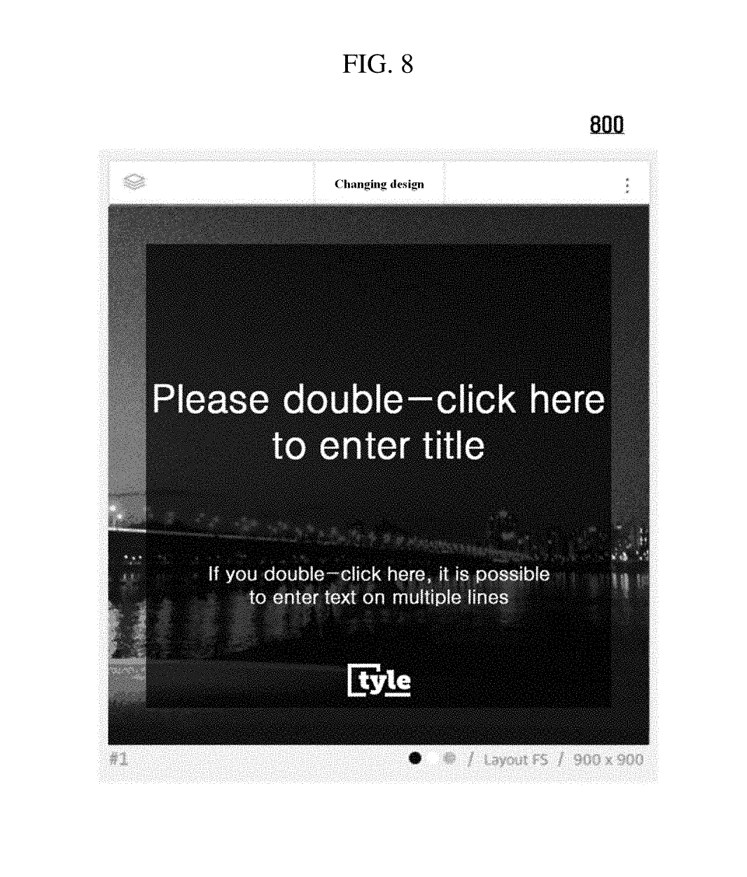

Referring to FIG. 8, the layout 800 of the card news provided to the user is illustrated.

In operation S620, the computer 10 receives a text from the user.

The computer 10 receives a user input to select a title text layout or a body text layout, receives a text from the user, and places the received text in the selected layout.

The computer 10 adjusts the size and the location of the text such that the received text is placed within the layout. For example, as the length of the text entered by the user increases, the computer 10 may reduce the size of the text such that the all texts are placed within the layout. Furthermore, when the line wrapping is included in the text, the computer 10 may increase or decrease the size of the line-wrapped text depending on the size of the remaining layout space.

In operation S630, the computer 10 may change the design or the layout of the card news at the request of the user.

For example, when the “changing design” button of card news 800 illustrated in FIG. 8 is selected, the computer 10 may automatically change at least one of the background, text design, and layout of the card news 800 and may provide the changed result to the user.

In operation S640, the computer 10 may extract the completed card news at the request of the user. The extracted card news may be stored in the format of an image file, a document file, or a presentation file or may be automatically uploaded onto the selected SNS.

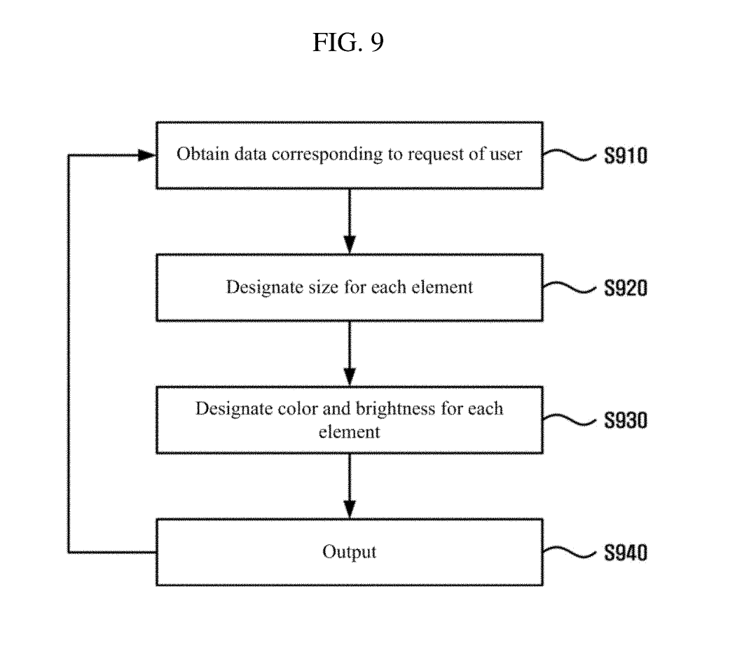

FIG. 9 is a view illustrating a flowchart of a method for producing card news in a loop form, according to a disclosed embodiment.

In operation S910, the computer 10 obtains data corresponding to a user's request. For example, the computer 10 obtains information necessary to generate the card news or information necessary to revise the generated card news.

According to an embodiment, when the user's request is input as a message through a chat, a preliminary task to classify whether the user's request refers to a title, content, or an image replacement request in the context of the conversation may be performed.

According to another embodiment, when the user's request is obtained through a preset user interface of a website or an application, since a title value, a content value, and an explicit value for image replacement are input, no extra task may be done.

The computer 10 performs a method for producing the card news according to a disclosed embodiment by adding the obtained user's request to the existing a total user request or by changing the existing the request.

In operation S920, the computer 10 designates the size for each element of each component to be included in the card news.

For example, the computer 10 designates the size of each of the elements to be included in the card news in order from a large element to a small element (e.g., in order of a frame, an image, a box, a text, and a logo).

The size of each element is based on the fact that the size is designated to be less than the size of another element designated immediately before. However, according to an embodiment, within a predetermined range (e.g., 20%), the size of another element, the size of which is designated immediately before, may be changed depending on the size of another element, the size of which is designated next. The predetermined range is not necessarily 20%, and may be set to 10% or 30%, and is not limited to the range of the disclosed embodiments.

For example, when the amount of text and the font size, which are requested by the user, are beyond the size of the box, the size of the box may be further expanded within a predetermined range. However, even though the amount of text and the size of a text are beyond the size of the box, it is possible not to exceed the area of the box by reducing the size of the text.

Accordingly, the size of each element is organically changed depending on elements, each of which the size is determined before and after while being not fixed, and thus it is possible to obtain a natural result.

According to an embodiment, the computer 10 designates the size for each component in specific order and performs color assignment and visibility reinforcement for each element in reverse order of the specified size.

In operation S930, the computer 10 designates the color and the brightness for each element.

According to an embodiment, the computer 10 designates the color of each element in reverse order of the order in which the size of each element is determined, that is, in order from a small element to a large element.

The computer 10 may designate the color and brightness of each element among the components for the purpose of enhancing the visibility of a text.

The method of enhancing the visibility of a text is based on the difference in brightness between the text and the surrounding components.

According to an embodiment, the elements located around the text are a box, an image, and a frame, and thus the surrounding of the text includes at least one or all of these three elements.

As a result, the computer 10 calculates the brightness expressed at a periphery of the text depending on the transparency, presence, and color of the box, the image, and the frame. The computer 10 compares the brightness at a periphery of the text with the brightness of the text to determine whether the difference in brightness is greater than the predetermined reference brightness difference (e.g., 50%).

When the brightness difference is less than the predetermined reference brightness difference, the computer 10 forcibly adjusts the brightness of a box, an image, and a frame Even though the brightness difference is not enough, the computer 10 may enhance the visibility of the text by using the outline or background color of the text.

In operation S940, the computer 10 outputs the result generated depending on operation S910 to operation S930.

For example, when the computer 10 executes one cycle, an object including information about the size, color, transparency, location and content for each element included in the card news is generated.

The computer 10 may store the generated objects in a database in a markup such as JSON/XML, and may extract the generated objects in the format of an image file or a video file depending on a method requested by the user to transmit the extracted result to an output unit.

The result transmitted to the output unit is the final output, but it is also in a waiting state for receiving the user's feedback. When the user does not end the task and provides an additional feedback, the computer 10 performs the card news generating method illustrated in FIG. 9 again from operation S910.

Accordingly, according to a disclosed embodiment, the computer 10 generates a design result in real time with respect to the user's request item, and repeats a state to wait for the user's feedback until the user is satisfied with the final result and then ends the task.

The steps of a method or algorithm described in connection with the embodiments of the present disclosure may be embodied directly in hardware, in a software module executed by hardware, or in a combination thereof. The software module may reside on a Random Access Memory (RAM), a Read Only Memory (ROM), an Erasable Programmable ROM (EPROM), an Electrically Erasable Programmable ROM (EEPROM), a Flash memory, a hard disk, a removable disk, a CD-ROM, or a computer readable recording medium in any form known in the art to which the invention pertains.

According to a disclosed embodiment, it is possible to automatically generate and provide card news including content requested by a user even if the user does not care about a design.

In addition, the user may obtain the result of the card news naturally as if the user is saying, by providing an interactive user interface. Furthermore, the learning curve is short because there is no need to learn how to use a tool to generate the card news separately.

Moreover, mass production of the card news based on a database is possible without the user's intervention on specific portions, and the card news is generated automatically, thereby shortening a production time.

Also, the card news is generated depending on the user's request item (e.g., the intent of content and a design), thereby enhancing the user's satisfaction.

The effects of the present inventive concept are not limited to the aforementioned effects, and other effects not mentioned herein will be clearly understood from the following description by those skilled in the art to which the present disclosure pertains.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for providing a card news producing service, the method comprising:
obtaining, by a computer, a card news generating request from a user;
extracting content of the card news from the obtained card news generating request;
generating a layout of the card news based on at least one of request items included in the extracted content and the card news generating request;
placing a text corresponding to the extracted content of the card news in the generated layout;
determining a design of the placed text;
determining a background of the card news; and
providing the card news to the user.

2. The method of claim 1, further comprising:
obtaining a feedback on the provided card news from the user;
extracting a revised item associated with the card news from the feedback;
revising the card news depending on the revised item; and
providing the revised card news to the user.

3. The method of claim 2, wherein the revising of the card news further includes:
changing a design of at least one of a text and a background of the revised card news to enhance visibility of the text of the revised card news.

4. The method of claim 3, wherein the changing of the design includes:
increasing a brightness difference between the text and the background of the revised card news so as to enhance the visibility of the text of the revised card news, and
wherein the changing of the design includes:
changing a color of the background of the card news or an image included in the background of the card news, when a color of a text of the card news is changed depending on the revised item; and
changing the color of the text of the card news, when the background of the card news is changed depending on the revised item.

5. The method of claim 1, wherein the determining of the background of the card news includes:
determining at least one image to be included in the background of the card news, and
wherein the determining of the background of the card news includes:
determining an image corresponding to the content of the extracted card news.

6. The method of claim 1, wherein the generating of the layout includes:
generating the layout based on at least one of a channel in which the card news is to be distributed, an amount of texts to be placed in the layout, a type of a text to be placed in the layout, and a type of a page to which the layout is to be applied.

7. The method of claim 1, wherein the generating of the layout includes:
generating one or more layers corresponding to each component of the layout, and
wherein the one or more layers includes one or more of a background layer, an image layer, a box layer, a logo layer, a body text layer, and a title text layer.

8. The method of claim 7, wherein the placing of the text includes:
classifying the text as at least one of a title text and a body text; and
placing the classified text in a corresponding layer.

9. The method of claim 1, wherein the placing of the text further includes:
adjusting a line wrapping and a font size of the text such that the text is placed in an area where the text is to be placed in the generated layout.

10. An application stored in a computer-readable recording medium such that a computer is capable of performing the method of claim 1.
